(19) United States
(12) Patent Application Publication
(10) Pub. No.: US 2023/0417987 A1
(43) Pub. Date: Dec. 28, 2023

(54) TECHNOLOGIES FOR EXPANDED BEAM OPTICAL CONNECTOR

(71) Applicant: Intel Corporation, Santa Clara, CA (US)

(72) Inventors: Wesley B. Morgan, Lake Oswego, OR (US); Stephen A. Smith, Laveen, AZ (US); Stephanie J. Arouh, Phoenix, AZ (US); Fan Fan, Chandler, AZ (US); Jianyong Mo, Chandler, AZ (US); Henry V. Wladkowski, Chandler, AZ (US)

(21) Appl. No.: 17/849,557

(22) Filed: Jun. 24, 2022

(51) Int. Cl. G02B 6/122; G02B 6/38; G02B 6/36; G02B 6/12

(52) U.S. Cl. CPC G02B 6/1225; G02B 6/3885; G02B 6/3853; G02B 6/3636; G02B 6/12004; G02B 2006/12102

(57) ABSTRACT

Technologies for expanded beam optical connectors are disclosed. In an illustrative embodiment, a lens array attached to a substrate includes several lenses aligned to optical fibers positioned in grooves in the substrate. The lens array also includes optical fiducials, such as opaque optical fiducials. Auxiliary optical fibers are aligned to the optical fiducials. Light can be sent through the auxiliary optical fibers and onto the optical fiducials, and a pattern of light can be detected after the optical fiducials. The pattern of light can be used to determine a position and/or orientation error of the lens array. The error can be used as feedback in several possible ways, such as repositioning the lens array, positioning a guide pin to match the position and direction of beams through the lenses, or adjusting a parameter of a manufacturing process.

### BACKGROUND

Photonic integrated circuits (PICs) can be used for several applications such as communications. Efficiently and cheaply aligning optics to couple light into and out of PICs can be a challenge. Approaches include using V-grooves to align a fiber connector or attaching a lens to the PIC. However, these approaches can be expensive and/or low-yield.

### BRIEF DESCRIPTION OF THE DRAWINGS

FIG. 1 is an isometric view of an optical connector with optical fiducials on a lens array.

FIG. 2 is a top-down view of the optical connector of FIG. 1 directed at a beam profiler sensor

FIG. 3 is a picture and graph of the intensity profile of one beam from one embodiment of the optical connector of FIG. 1.

FIG. 4 is a picture and graph of the intensity profile of one beam from one embodiment of the optical connector of FIG. 1.

FIG. 5 is a picture and graph of the intensity profile of one beam from one embodiment of the optical connector of FIG. 1.

FIG. 6 is an isometric view of an optical connector with optical fiducials in a different plane from lenses in a lens array.

FIG. 7 is a side view of the optical connector of FIG. 6 with an axially aligned lens array.

FIG. 8 is a side view of the optical connector of FIG. 6 with a tilted lens array.

FIG. 9 is a picture of the intensity profile of an array of beams from one embodiment of the optical connector of FIG. 6.

FIG. 10 is a picture of the intensity profile of an array of beams from one embodiment of the optical connector of FIG. 6.

FIG. 11 is a picture of the intensity profile of an array of beams from one embodiment of the optical connector of FIG. 6.

FIG. 12 is a picture of the intensity profile of an array of beams from one embodiment of the optical connector of FIG. 6.

FIG. 13 is a picture of the intensity profile of an array of beams from one embodiment of the optical connector of FIG. 6.

FIG. 14 is a picture of the intensity profile of an array of beams from one embodiment of the optical connector of FIG. 6.

FIG. 15 graph of beam angle difference between an auxiliary channel and lensed channel as a function of lens array tilt for one embodiment of the optical connector of FIG. 6.

FIG. 16 is an isometric view of an optical connector with a micro lens array as optical fiducials in a different plane from lenses in a lens array.

FIG. 17 is a picture of the intensity profile of one beam from one embodiment of the optical connector of FIG. 16.

FIG. 18 is a picture of the intensity profile of one beam from one embodiment of the optical connector of FIG. 16.

FIG. 19 is a picture of the intensity profile of one beam from one embodiment of the optical connector of FIG. 16.

FIG. 20 is an isometric view of an optical connector with optical fiducials in two different planes from lenses in a lens array.

FIG. 21 is an isometric view of an optical connector with auxiliary channels not passing through a lens array.

FIG. 22 is an isometric view of an optical connector with lenses of the lens array in different planes.

FIG. 23 is a simplified flow diagram of at least one embodiment of a method for manufacturing an optical connector.

FIG. 24 is a side view of the optical connector of FIG. 1 with an axially aligned lens array.

FIG. 25 is a side view of the optical connector of FIG. 1 with a misaligned lens array and tilted guide pin to compensate for the lens array misalignment.

FIG. 26 is a top view of a wafer and dies that may be included in a microelectronic assembly, in accordance with any of the embodiments disclosed herein.

FIG. 27 is a cross-sectional side view of an integrated circuit device that may be included in a microelectronic assembly, in accordance with any of the embodiments disclosed herein.

FIGS. 28A-28D are perspective views of example planar, gate-all-around, and stacked gate-all-around transistors.

FIG. 29 is a cross-sectional side view of an integrated circuit device assembly that may include a microelectronic assembly, in accordance with any of the embodiments disclosed herein.

FIG. 30 is a block diagram of an example electrical device that may include a microelectronic assembly, in accordance with any of the embodiments disclosed herein.

### DETAILED DESCRIPTION

In various embodiments disclosed herein, a lens assembly is secured to an optical connector to facilitate coupling into and out of waveguides attached to or integrated with the optical connector. In the illustrative embodiment, the lens array includes one or more optical fiducials. Auxiliary waveguides can transmit light through the lens array and onto one or more optical fiducials. A beam profiler sensor detects the pattern of light and can determine the position and/or orientation of the lens array. The position and/or orientation of the lens array may be used as feedback in various ways, such as repositioning the lens array before permanently attaching it, adjusting a parameter of a manufacturing process, or aligning guide pins to match the direction of a beam after it exits the lens array.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that sends signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

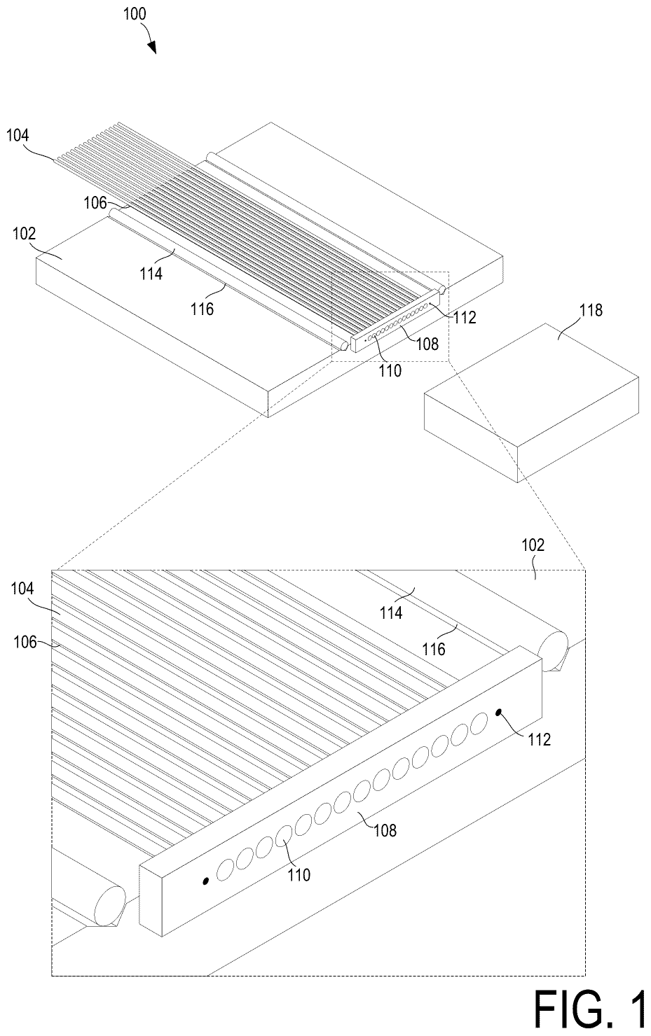

Referring now to FIG. 1, in one embodiment, an optical connector 100 includes a substrate 102 that supports several optical fibers 104 in V-grooves 106 defined in a top surface of the substrate 102. The optical fibers 104 extend to one end of the substrate, directing the light from the optical fibers 104 to lenses 110 of a lens array 108 positioned at one end of the substrate 102. In use, the lenses 110 of the lens array 108 collimate light from the optical fibers 104, relaxing the position tolerance to couple to another component, such as another optical connector 118.

In one illustrative embodiment, the optical fiber 104 at each end of the array of optical fibers 104 is an auxiliary optical fiber. The lens array 108 includes opaque optical fiducials 112 that absorb, reflect, or scatter some or all of the light from the auxiliary optical fibers 104. As discussed in more detail below, the pattern of light from the auxiliary optical fibers 104 after the optical fiducials 112 can be used to determine misalignment of the lens array 108. In the illustrative embodiment, the optical fibers 104 aligned to lenses 110 are used to send and/or receive data, while the auxiliary optical fibers 104 aligned to optical fiducials 112 are used for alignment.

The optical connector 100 also includes one or more guide pins 114 positioned in grooves 116 defined in the top surface of the substrate 102. The guide pins 114 may be used to position the optical connector 100 relative to a connector to which the optical connector 100 is mated, such as the connector 118.

The optical connector 100 may include any suitable number of optical fibers 104, such as 2-1,024. The optical connector 100 may form part of a cable connecting two components or may be part of a component such as a switch, a compute device, a memory, a fabric, etc.

The substrate 102 may be any suitable material, such as glass (e.g., silicon oxide) or silicon. The optical fibers 104 may be any suitable fibers, such as single-mode glass fibers. In the illustrative embodiment, the optical connector 100 supports optical fibers 104 on a surface of the optical connector 100. In other embodiments, a photonic integrated circuit (PIC) 100 may have waveguides 104 defined near a top surface of the PIC 100. In such an embodiment, the waveguides 104 in the substrate 102 may extend to one end of the PIC 100 and direct light into the lens array 108 in a similar manner as for the optical connector 100 described above. As used herein, a waveguide may refer to either an optical fiber or to an optical waveguide defined in a bulk substrate. Although various embodiments described herein refer to optical fibers 104 in an optical connector 100, it should be appreciated that the optical fibers 104 may be replaced by waveguides defined in the substrate 102. Such a PIC 100 may include one or more light sources, detectors, splitter, filters, amplifiers, attenuators, etc. A PIC 100 may be coupled to one or more suitable electrical integrated circuits, such as a processor, a memory, a switch, etc.

The optical fibers 104 and/or waveguides 104 may support modes of light at any suitable wavelength, such as 1,000-1,600 nanometers, including, e.g., light in the C-band, O-band, L-band, S-band, etc.

The lens array 108 may be made of any suitable material, such as glass (e.g., silicon oxide), silicon, plastic, etc. In the illustrative embodiment, the lenses 110 have a focal length of about 100 micrometers and collimate light from the fibers 104 to a beam diameter of about 100 micrometers. In other embodiments, the lenses 110 of the lens array 108 may have any suitable focal length, such as 10-1,000 micrometers, and may collimate light from the fibers 104 to a beam diameter of any suitable size, such as 10-1,000 micrometers.

The opaque optical fiducials 112 may be any suitable size, such as 1-50 micrometers. The opaque optical fiducials 112 may absorb any suitable amount of the light from the auxiliary fibers 104, such as 5-95%. The opaque optical fiducials 112 may absorb, reflect, or scatter light. In some embodiments, the optical fiducials 112 may cause a phase change in the light without significantly absorbing it. The opaque optical fiducials 112 may be made of any suitable material, such as carbon, silver, aluminum, an interference film, etc. In the illustrative embodiment, the opaque optical fiducials 112 are circular. In other embodiments, the opaque optical fiducials 112 may have any suitable shape, such as a ring.

The guide pins 114 may be made of any suitable material, such as iron, steel, aluminum, other metal, plastic, ceramic, etc. The guide pins 114 may have any suitable diameter or length, such as a diameter of, e.g., 100 micrometers to 5 millimeters and a length of, e.g., 1-25 millimeters. In some embodiments, the guide pins 114 may be monolithically integrated into the substrate 102.

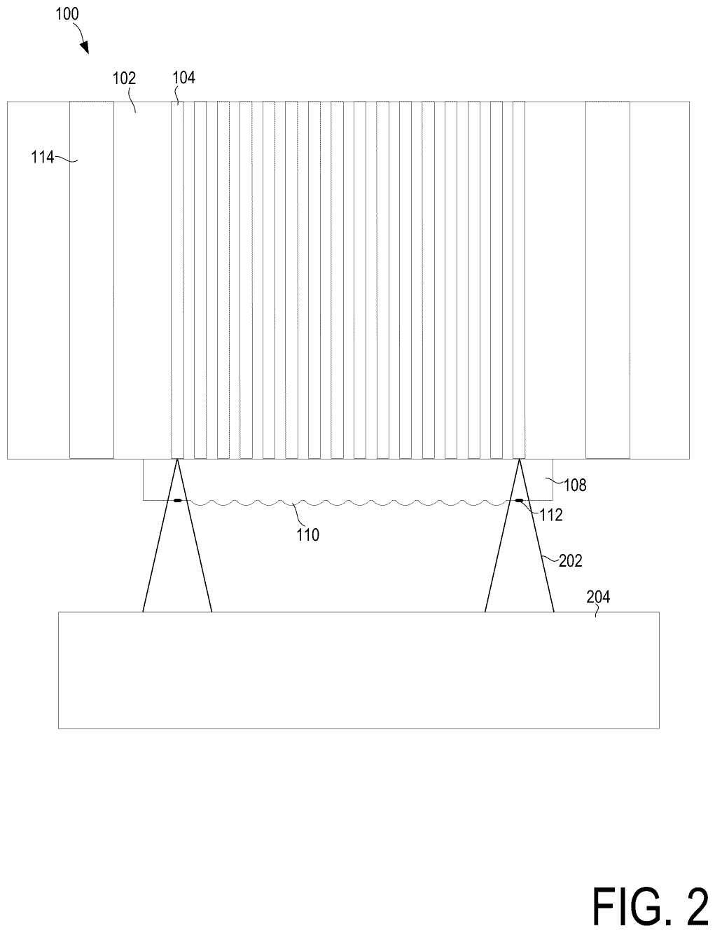

Referring now to FIG. 2, in one embodiment, an optical connector has light passing through the two auxiliary optical fibers 104 aligned to the opaque optical fiducials 112. A beam profiler sensor 204 is positioned to sense the beams 202 from the auxiliary optical fibers 104 after they are partially obscured by the opaque optical fiducials 112. The beam profiler sensor 204 may be embodied as any suitable sensor that can detect a beam profile. In the illustrative embodiment, the beam profiler sensor 204 is a two-dimensional array of light-sensitive pixels, such as a charge-coupled device (CCD) sensor, complementary metal-oxide semiconductor (CMOS) sensor, or other 2D light sensor. In other embodiments, the beam profiler sensor 204 may use a different sensor, such as one or more moving slits. The beam profiler sensor 204 may be placed any suitable distance from the lens array 108, such as 2-20 millimeters. In the illustrative embodiment, the beam profiler sensor 204 is placed about 10 millimeters from the lens array 108.

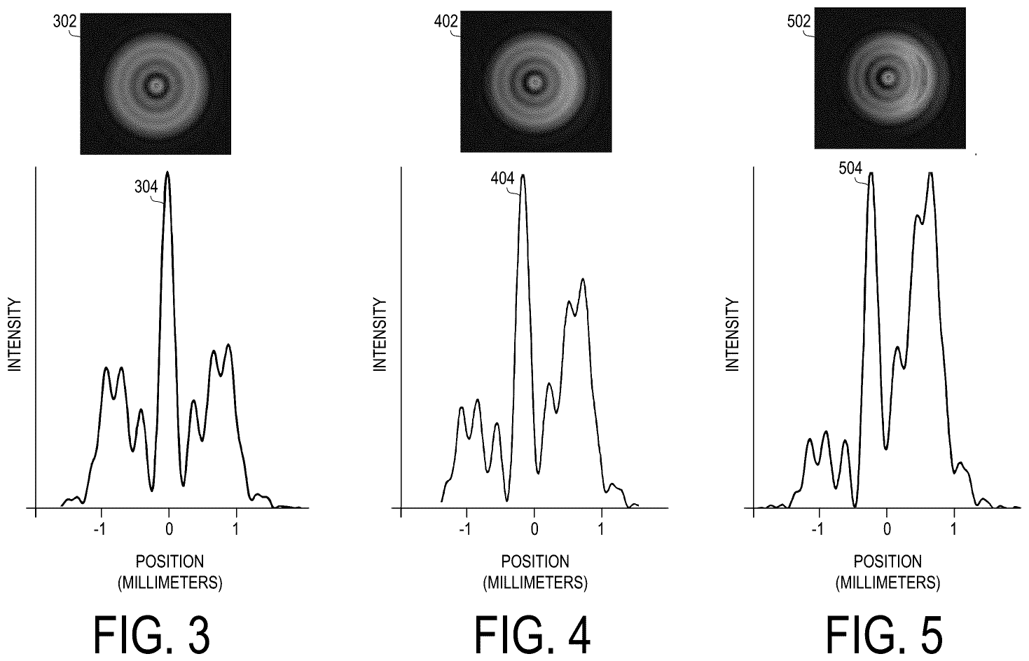

The beam profiler sensor 204 may generate one-dimensional or two-dimensional intensity data. FIGS. 3-5 show a one-dimensional plot of intensity data taken at a cross-section of a simulated two-dimensional image. The corresponding two-dimensional image is shown above each plot. The opaque optical fiducial 112 in the shape of a disc blocks part of the Gaussian beam coming from the auxiliary optical fibers 104, causing a diffraction pattern. If the lens array 108 is well-aligned, the opaque optical fiducials 112 will be centered on the beam from the auxiliary optical fibers 104, leading to a symmetric diffraction pattern. However, if the opaque optical fiducials 112 are offset, then the diffraction pattern will be asymmetric. In the illustrative embodiment, the beam profiler sensor 204 can locate a center of a beam with a precision of about 3.5 micrometers. In other embodiments, the beam profiler sensor 204 can locate a center of a beam with any suitable precision, such as 1-10 micrometers. In the illustrative embodiment, the beam profiler sensor 204 can determine relative directions of beams within about 0.02°. In other embodiments, the beam profiler sensor 204 can locate relative directions of beams with any suitable precision, such as 0.01-0.1°.

For example, FIG. 3 shows a diffraction pattern 302 and a cross-sectional intensity 304 of an opaque optical fiducial 112 that is offset by about one micrometer. FIG. 4 shows a diffraction pattern 402 and a cross-sectional intensity 404 of an opaque optical fiducial 112 that is offset by about five micrometers. FIG. 5 shows a diffraction pattern 502 and a cross-sectional intensity 504 of an opaque optical fiducial 112 that is offset by about 10 micrometers.

The opaque optical fiducials 112 can be used to sense the offset of the lens array 108 in the plane perpendicular to the direction of the axis of the beams from the optical fibers 104. However, the diffraction patterns 302, 402, 502 are relatively insensitive to pitch and yaw.

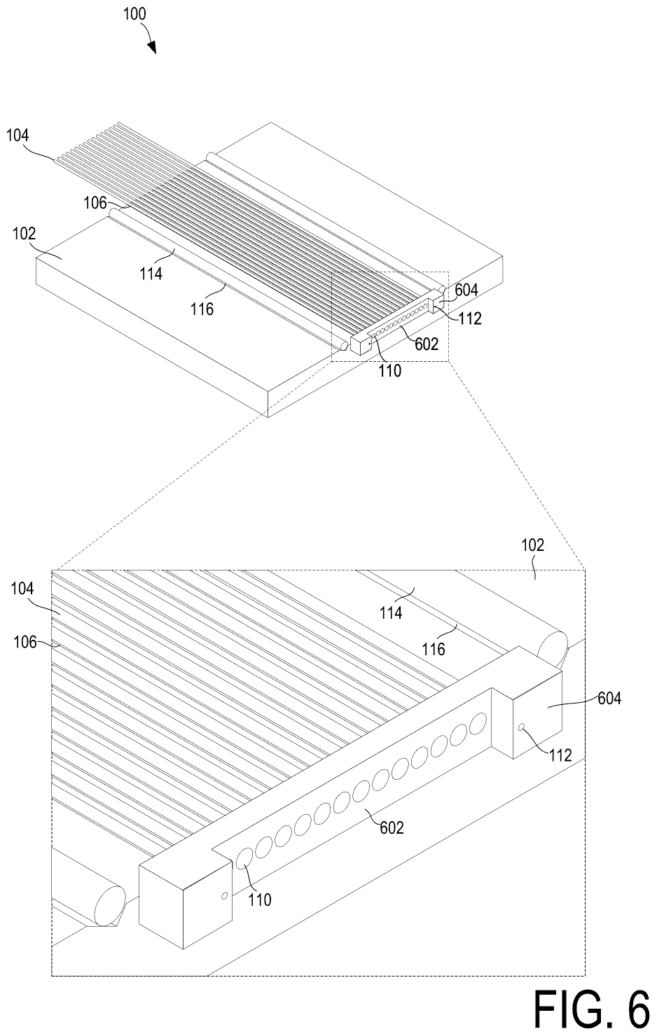

Referring now to FIG. 6, in one embodiment, an optical connector 100 may include a lens array 602 with a protrusion 604 at each end. An opaque optical fiducial 112 is positioned on each protrusion 604. The protrusions 604 place the opaque optical fiducials 112 in a different plane from the lenses 110 in the lens array. Other than the protrusion 604, the lens array 602 may be similar to the lens array 108. The protrusion 604 may protrude by any suitable amount, such as 10-1,000 micrometers. Additionally or alternatively, in some embodiments, the opaque optical fiducials 112 may be positioned on a surface that is recessed relative to the lenses 110. Such a surface may be recessed by any suitable amount, such as 10-1,000 micrometers.

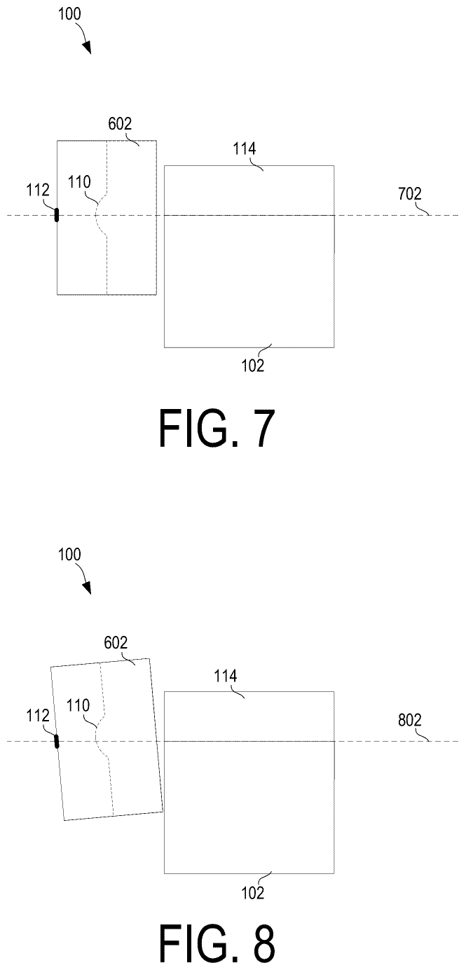

Referring now to FIGS. 7 and 8, side views of the optical connector 100 with the lens array 602 are shown. In FIG. 7, the lens array 602 is not offset or tilted relative to the substrate 102, and the axis 702 parallel to the optical fibers 104 passes through the center of the lenses 110 and the opaque optical fiducials 112. In FIG. 8, the lens array 602 is tilted relative to the substrate 102. As a result, the axis 802 parallel to the optical fibers 104 does not pass through the center of the lenses 110. However, because the opaque optical fiducials 112 are in a different plane than the lenses 110, the axis can still pass through the center of the opaque optical fiducials 112. More generally, the fact that the opaque optical fiducials 112 are in a different plane than the lenses 110 means that a tilt will result in a positional shift in the lenses 110 relative to the opaque optical fiducials 112.

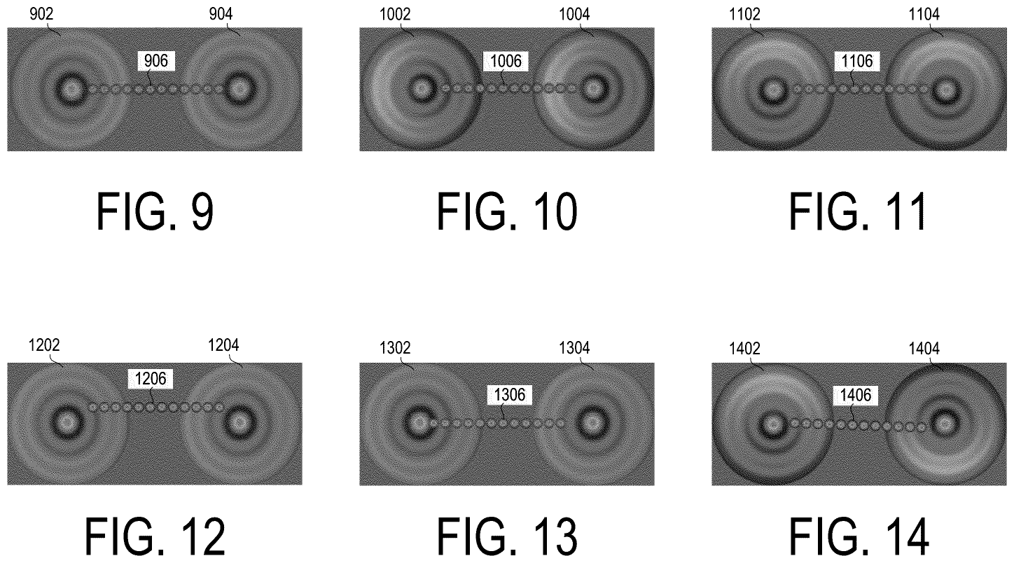

Referring now to FIGS. 9-14, some examples of simulated images from a beam profiler sensor 204 are shown for the lens array 602. In the examples, light is sent through the auxiliary optical fibers 104 aligned to the opaque optical fiducials 112 as well as through the optical fibers 104 aligned to the lenses 110. FIG. 9 shows two diffraction patterns 902, 904 for the auxiliary optical fibers 104 and the array of beams 906 from the lenses 110 for a lens array that is not tilted or decentered in any direction. FIG. 10 shows two diffraction patterns 1002, 1004 for the auxiliary optical fibers 104 and the array of beams 1006 from the lenses 110 for a lens array that is not tilted but is shifted in the direction parallel to the surface of the substrate 102 and perpendicular to the direction of the optical fibers 104. FIG. 11 shows two diffraction patterns 1102, 1104 for the auxiliary optical fibers 104 and the array of beams 1106 from the lenses 110 for a lens array that is not tilted but is shifted in the direction perpendicular to the surface of the substrate 102 and perpendicular to the direction of the optical fibers 104. FIG. 12 shows two diffraction patterns 1202, 1204 for the auxiliary optical fibers 104 and the array of beams 1206 from the lenses 110 for a lens array that is not is shifted in any direction (at the plane of the opaque optical fiducials 112) but is tilted in the pitch direction. FIG. 13 shows two diffraction patterns 1302, 1304 for the auxiliary optical fibers 104 and the array of beams 1306 from the lenses 110 for a lens array that is not is shifted in any direction (at the plane of the opaque optical fiducials 112) but is tilted in the yaw direction. FIG. 14 shows two diffraction patterns 1302, 1304 for the auxiliary optical fibers 104 and the array of beams 1306 from the lenses 110 for a lens array that is not is shifted, on average, in any direction (at the plane of the opaque optical fiducials 112) but is tilted in the roll direction.

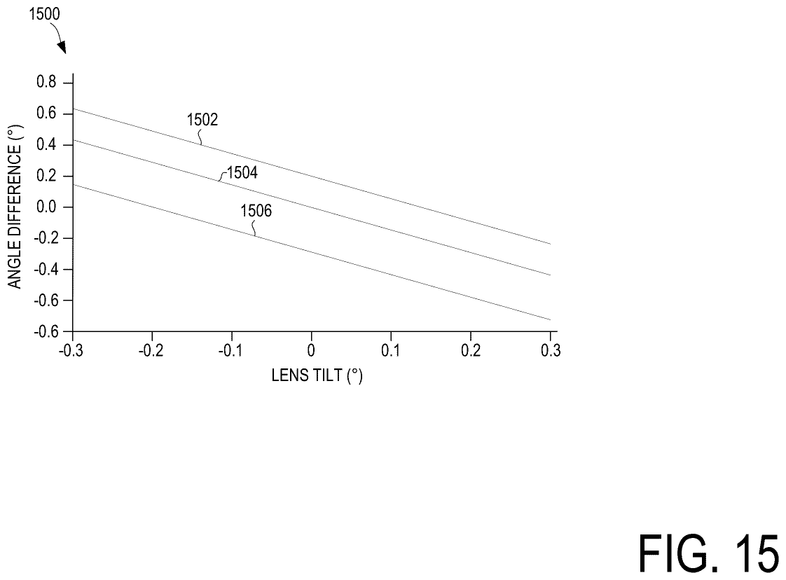

Referring now to FIG. 15, in one embodiment, a plot 1500 shows the simulated angle difference of light from an auxiliary optical fiber 104 aligned to an opaque optical fiducial 112 on a 0.6-millimeter protrusion as a function of the tilt of the lenses 110. The plot 1500 shows the simulated angle difference for a decenter of 1.5 micrometers 1502, a decenter of 0 micrometers 1504, and a decenter of −2.1 micrometers 1506.

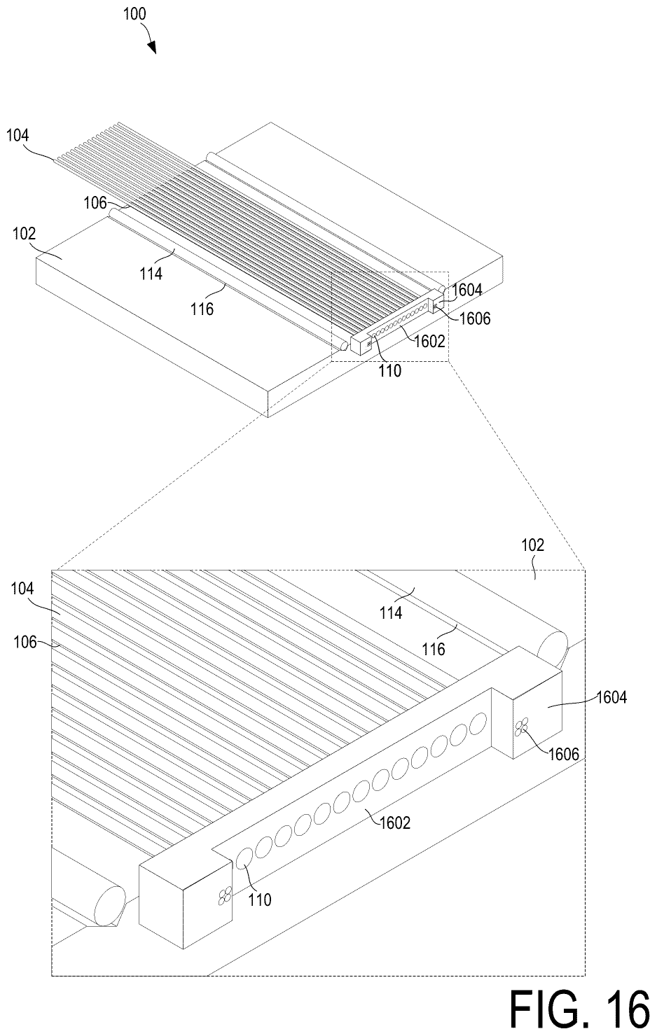

Referring now to FIG. 16, in one embodiment, an optical connector 100 may include a lens array 1602 with a protrusion 1604 at each end. Instead of an opaque optical fiducial 112, a lenslet array optical fiducial 1606 is positioned on each protrusion 1604. A pattern of, e.g., four smaller, clustered lenses will collimate light from the optical fiber 104, creating a similar pattern of beam spots that can be detected by the beam profiler sensor 204. The lenslet array optical fiducial 1606 may include any suitable number of lenses, such as 2-10. As for the lens array 602, the lens array 1602 places the lenslet array optical fiducials 1606 in a different plane from the lenses 110 in the lens array. Other than the lenslet array optical fiducial 1606, the lens array 1602 may be similar to the lens array 602. It should be appreciated that, in various embodiments disclosed herein, some or all of the opaque optical fiducials 112 may be replaced by lenslet array optical fiducials 1606.

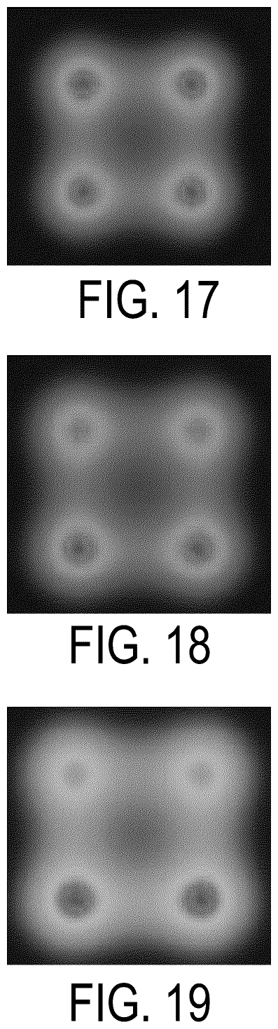

Referring now to FIGS. 17-19, some examples of simulated images from a beam profiler sensor 204 are shown for the lens array 1602. FIG. 17 shows a simulated pattern on the beam profiler sensor 204 for a lenslet array optical fiducial 1606 that is centered on the light from the auxiliary optical fiber 104. FIG. 18 shows a simulated pattern on the beam profiler sensor 204 for a lenslet array optical fiducial 1606 that is decentered on the light from the auxiliary optical fiber 104 by one micrometer FIG. 19 shows a simulated pattern on the beam profiler sensor 204 for a lenslet array optical fiducial 1606 that is decentered on the light from the auxiliary optical fiber 104 by two micrometers.

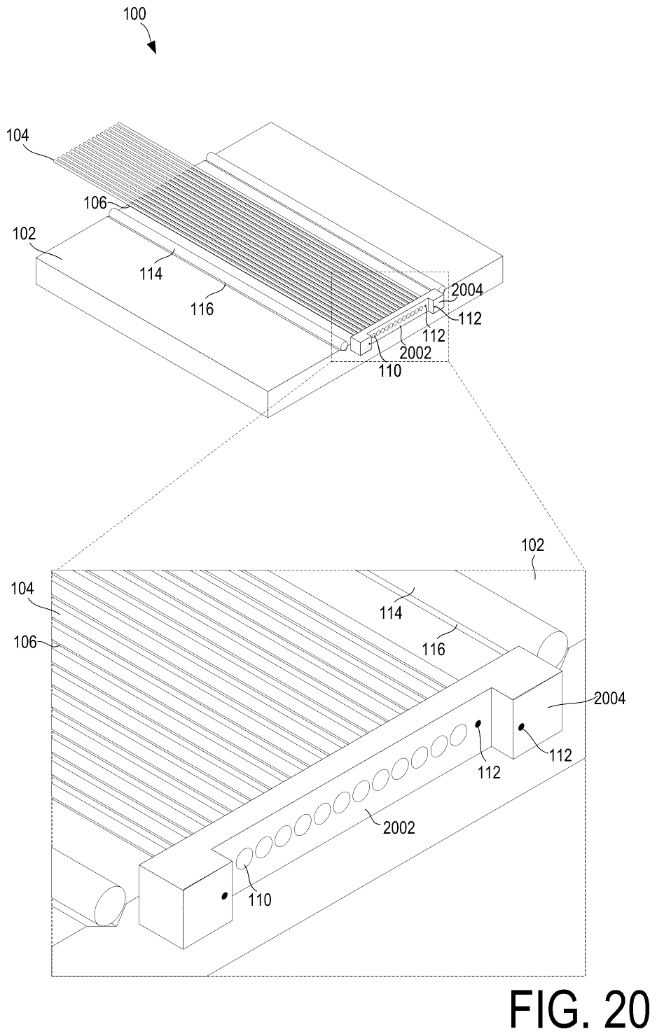

Referring now to FIG. 20, in one embodiment, an optical connector 100 may include a lens array 2002 with a protrusion 2004 at each end of the lens array 2002. The lens array 2002 includes two opaque optical fiducials 112 at each end, one on the same plane as the lenses 110 and one on a protrusion 2004. In such an embodiment, auxiliary optical fibers 104 may be aligned to each of the opaque optical fiducials 112. Centering the beams from the auxiliary optical fibers 104 on each of the opaque optical fiducials will align both the position and orientation of the lens array 2002.

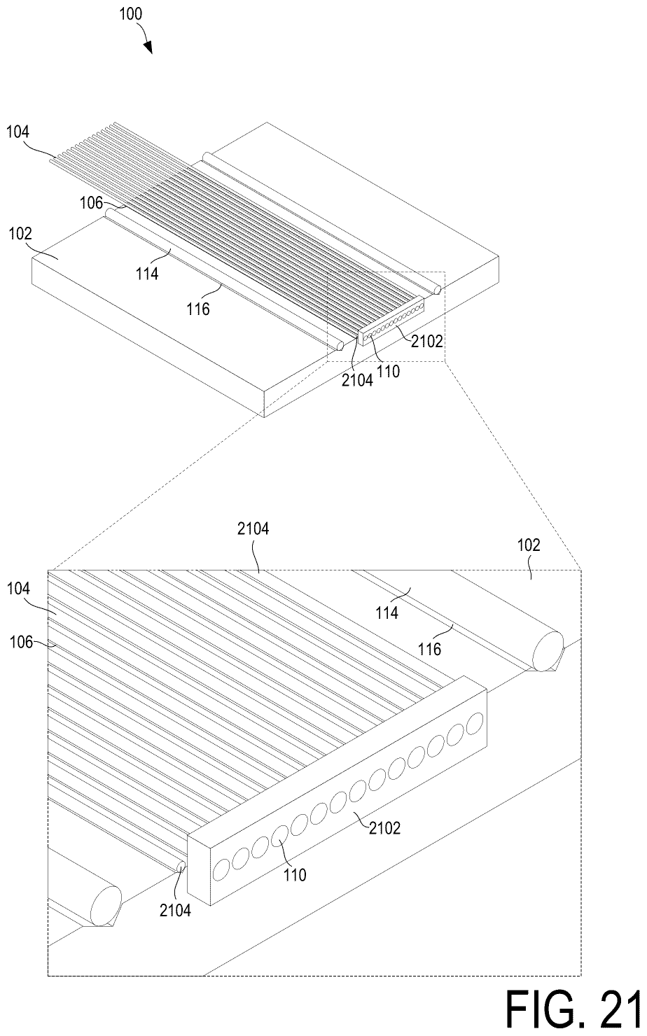

Referring now to FIG. 21, in one embodiment, an optical connector 100 may include a lens array 2102 that does not extend to auxiliary fibers 2104 at either end of the array of optical fibers 104. The center of the beam from the auxiliary optical fibers 2104 as measured by a beam profiler sensor 204 can be used as a zero-offset reference for calculating beam angles of beams collimated by the lenses 110. The diameter of the beams from the optical fibers 104 can be used to calculate the distance from the substrate 102 to the beam profiler sensor 204. In the illustrative embodiment, reference optical fibers with a known good beam point (or a known good perpendicularity of the cleave angle) are used as the auxiliary fibers 2214. The reference fibers may be removed before final packaging of the optical connector 100. In other embodiments, the auxiliary optical fibers 2104 may be placed in a similar manner as the rest of the optical fibers and remain in place for final packaging of the optical connector 100.

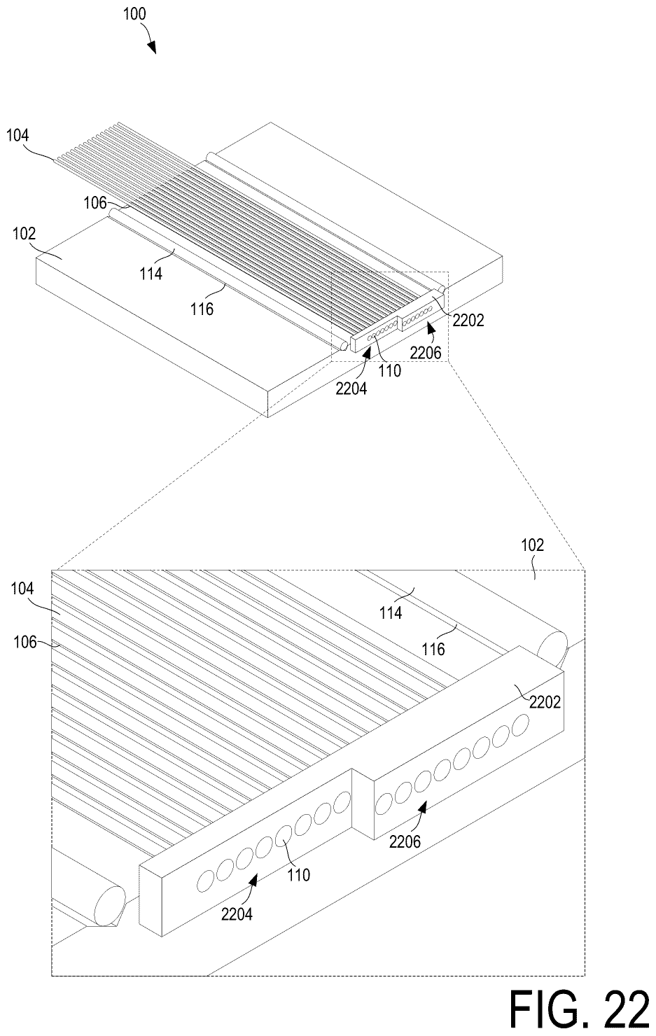

Referring now to FIG. 22, in one embodiment, an optical connector 100 may include a lens array 2202 with a first set of lenses 2204 and a second set of lenses 2206. The second set of lenses 2206 is positioned in a different plane from the first set of lenses 2204, as shown in FIG. 22. The separation between the plane defined by the first set of lenses 2204 and the plane defined by the second set of lenses 2206 may by any suitable amount, such as 10-1,000 micrometers. In the illustrative embodiment, both the first set of lenses 2204 and the second set of lenses 2206 collimate the beams from the optical fibers 104, but with different beam waists. The difference in beam waists may slightly affect coupling to other components, or the other components may have a similar configuration to couple sets of beams with different diameters. Because the second set of lenses 2206 is in a different plane from the first set of lenses 2204, if the lens array 2202 is tilted or decentered with respect to the core of the optical fibers 104, there will be point angle differences measured as beam spot location differences in the beam profiler sensor 204. Decenter detection may also be enhanced by adding aspheric properties to the lens shape, such as a small lenslet, flat spot, or depression at the center or a pattern of these features placed around the perimeter of each lens 110. The beam's Gaussian power distribution would be impacted slightly, but the design of the aspheric inclusion would be designed for only a small impact to coupling efficiency.

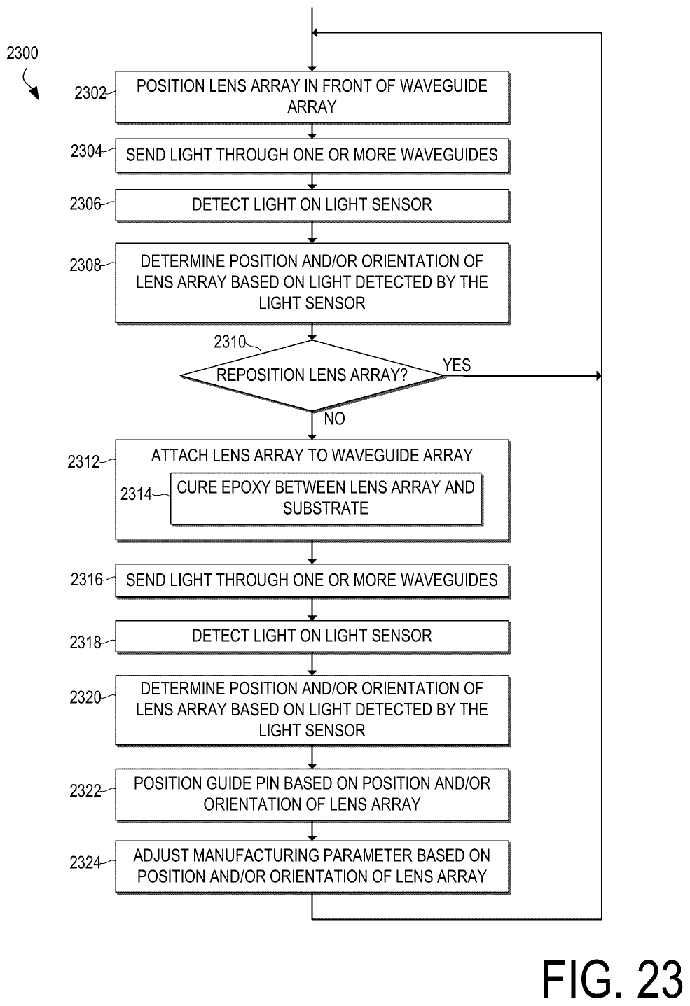

Referring now to FIG. 23, in one embodiment, a flowchart for a method 2300 for creating the optical connector 100 is shown. The method 2300 may be executed by a technician and/or by one or more automated machines. In some embodiments, one or more machines may be programmed to do some or all of the steps of the method 2300. Such a machine may include, e.g., a memory, a processor, data storage, etc. The memory and/or data storage may store instructions that, when executed by the machine, causes the machine to perform some or all of the steps of the method 2300. The method 2300 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, thermal treatments, flip chip, layer transfer, magnetron sputter deposition, pulsed laser deposition, pick-and-place, etc. It should be appreciated that the method 2300 is merely one embodiment of a method to create the optical connector 100, and other methods may be used to create the optical connector 100. In some embodiments, steps of the method 2300 may be performed in a different order than that shown in the flowchart.

The method 2300 begins in block 2302, in which a lens array 108 (or lens array 602, 1602, etc.) is positioned in from of an array of waveguides 104. The waveguides 104 may be, e.g., optical fibers 104 positioned in a V-groove on a surface of a substrate 102, waveguides 104 defined in a bulk of a substrate 102, etc.

In block 2304, light is sent through one or more of the waveguides 104. Light may be sent through auxiliary waveguides 104 aligned to optical fiducials (such as optical fiducials 112, 1606) and/or through waveguides 104 aligned to lenses 110. In block 2306, light sent through the waveguides 104 is detected on a light sensor 204, such as a beam profiler sensor 204.

In block 2308, the position and/or orientation of the lens array 108 relative to the substrate 102 of the optical connector 100 is determined. For example, the diffraction pattern of a beam obscured by an opaque optical fiducial 112 may be used to determine the offset of the opaque optical fiducial 112 relative to the auxiliary optical fiber 104, the pattern of beams through a lenslet array optical fiducial 1606 may be used to determine the offset of the lenslet array optical fiducial 1606 relative to the auxiliary optical fiber 104, the relative positions of beams passing through lenses 110 and optical fiducials 112 or 1606 at different planes may be used to determine a tilt of the lens array 108, and/or any other suitable technique may be used.

In block 2310, if the lens array 108 should be repositioned (e.g., due to a position error and/or tilt error being higher than a threshold), the method 2300 loops back to block 2302 to reposition the lens array 108 in front of the array of waveguides 104. If the lens array 108 should not be repositioned, the method 2300 proceeds to block 2312, in which the lens array 108 is attached to the array of waveguides 104. In the illustrative embodiment, the lens array 108 is attached by curing an epoxy between the lens array 108 and the substrate 102.

In block 2316, light is sent through one or more of the waveguides 104 in a similar manner as for block 2304. In block 2318, light is detected at a light sensor 204 in a similar manner as for block 2306. In block 2320, the position and/or orientation of the lens array 108 relative to the substrate 102 of the optical connector 100 is determined in a similar manner as for block 2306.

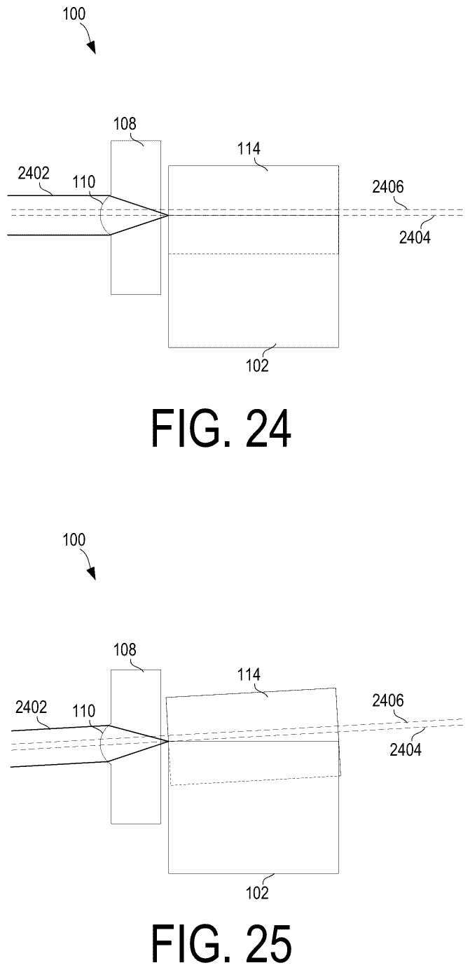

In block 2322, one or more guide pins 114 are positioned and attached based on the position and/or orientation of the lens array 108. In the illustrative embodiment, the guide pins 114 are positioned and attached at a fixed position relative to the beams from the lenses 110 of the lens array 108 and with the same orientation as the beams from the lenses 110. For example, in FIG. 24, a lens array 108 is shown with no position or tilt error, and the axis 2404 defining the center of a beam 2402 from a lens 110 is in the plane defined by the optical fibers 104 and passes through the center of the lens 110. An axis 2406 passing through the center of the guide pin 114 is parallel to the axis 2404, with a fixed offset. In FIG. 25, the lens array 108 is shifted downward, deflecting the beam 2402 downward. As a result of the shift of the lens array 108, the axis 2404 is pointing downward as well. The guide pin 114 is tilted and shifted such that the axis 1406 of the guide pin 114 is parallel to the axis 2404, with the same relative offset. The guide pin 114 may be positioned with a precision of, e.g., less than 0.01-0.1° and less than 0.5-3 micrometers. In the illustrative embodiment, the guide pin 114 may be positioned with a precision of less than 0.02° and less than one micrometer. As a result, a component mating with the optical connector 100 can use the guide pins 114 to determine the position and direction of beams out of the lenses 110. The guide pins 114 may be oriented at any suitable angle relative to a top surface of the substrate, such as −2 to 2 degrees.

In block 2324, in some embodiments, a manufacturing parameter may be adjusted based on the position and/or orientation of the lens array 108. For example, if the lens array 108 was placed with an offset in a particular direction, a parameter may be changed to place the lens array 108 in a different position to compensate for the measured offset. The method 2300 may then loop back to block 2302 to position the next lens array 108.

It should be appreciated that, in various embodiments, not all of the steps of the method 2300 may be performed. For example, in some embodiments, the position and/or orientation of the lens array 108 may only be determined after the lens array 108 is epoxied or otherwise permanently fixed to the substrate 102. The position and/or orientation of the lens array 108 may be used to determine the position of the guide pin 114 and/or may be used as feedback for a parameter of the manufacturing process. In another embodiment, the position and/or orientation of the lens array 108 may only be determined before the lens array 108 is epoxied or otherwise permanently fixed to the substrate 102. In such embodiments, the position of the lens array 108 may be corrected before the lens array 108 is epoxied, and any shift caused by applying the epoxy may be insignificant or not corrected.

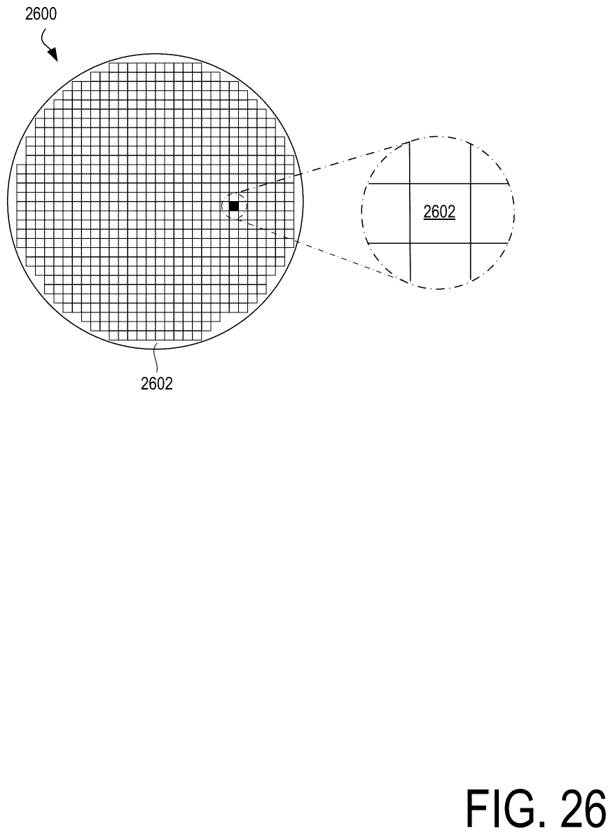

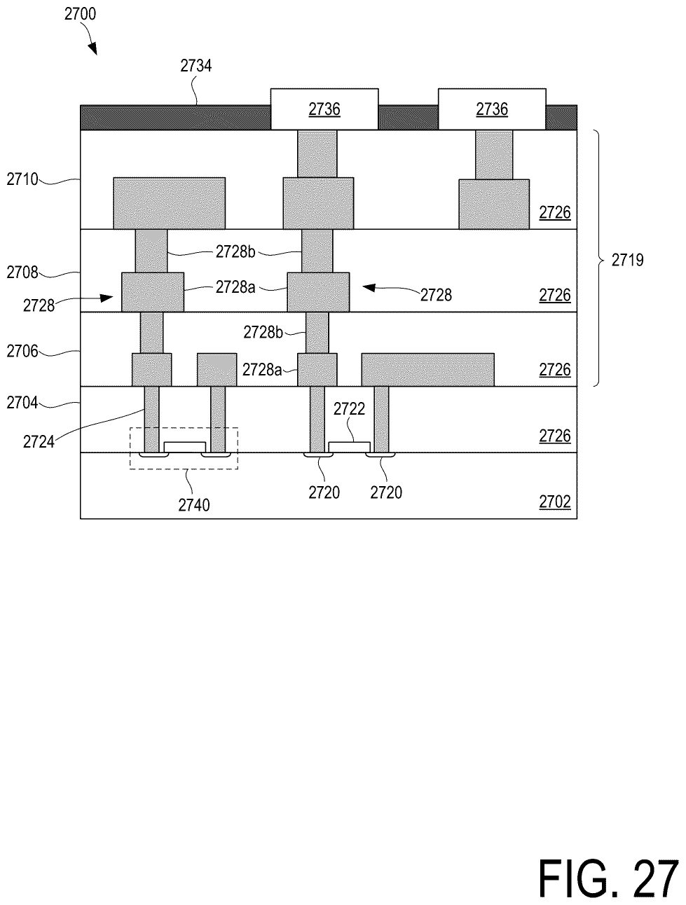

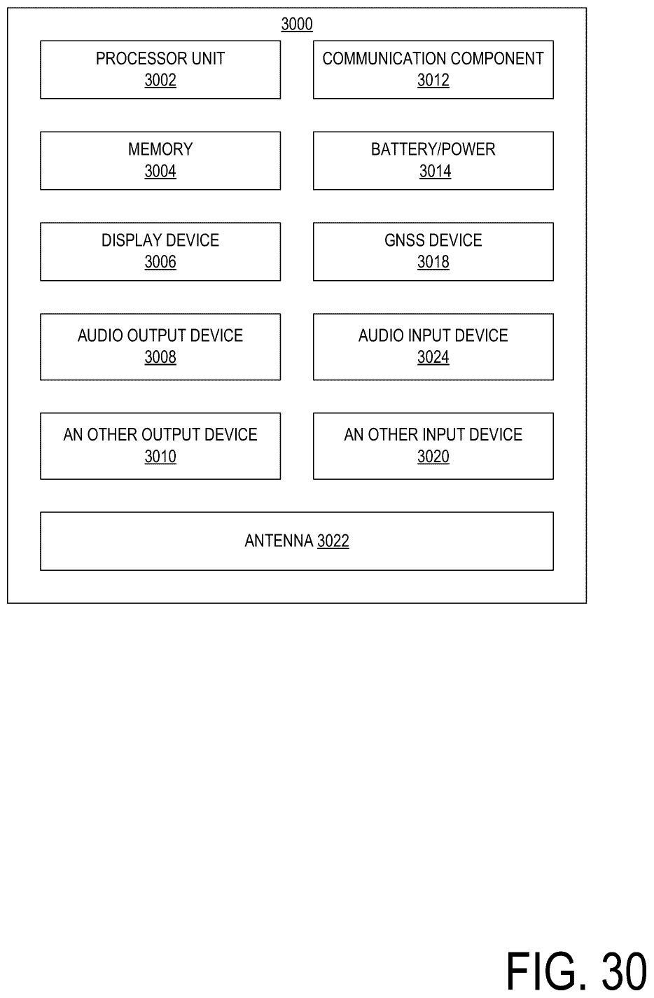

FIG. 26 is a top view of a wafer 2600 and dies 2602 that may be included in any of the systems disclosed herein. The wafer 2600 may be composed of semiconductor material and may include one or more dies 2602 having integrated circuit structures formed on a surface of the wafer 2600. The individual dies 2602 may be a repeating unit of an integrated circuit product that includes any suitable integrated circuit. After the fabrication of the semiconductor product is complete, the wafer 2600 may undergo a singulation process in which the dies 2602 are separated from one another to provide discrete “chips” of the integrated circuit product. The die 2602 may be any of the PIC dies 102 disclosed herein. The die 2602 may include one or more transistors (e.g., some of the transistors 2740 of FIG. 27, discussed below), supporting circuitry to route electrical signals to the transistors, passive components (e.g., signal traces, resistors, capacitors, or inductors), and/or any other integrated circuit components. In some embodiments, the wafer 2600 or the die 2602 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 2602. For example, a memory array formed by multiple memory devices may be formed on a same die 2602 as a processor unit (e.g., the processor unit 3002 of FIG. 30) or other logic that is configured to store information in the memory devices or execute instructions stored in the memory array. Various ones of the microelectronic assemblies disclosed herein may be manufactured using a die-to-wafer assembly technique in which some dies are attached to a wafer 2600 that include others of the dies, and the wafer 2600 is subsequently singulated.

FIG. 27 is a cross-sectional side view of an integrated circuit device 2700 that may be included in any of the microelectronic assemblies disclosed herein (e.g., in any of the PIC dies 102). One or more of the integrated circuit devices 2700 may be included in one or more dies 2602 (FIG. 26). The integrated circuit device 2700 may be formed on a die substrate 2702 (e.g., the wafer 2600 of FIG. 26) and may be included in a die (e.g., the die 2602 of FIG. 26). The die substrate 2702 may be a semiconductor substrate composed of semiconductor material systems including, for example, n-type or p-type materials systems (or a combination of both). The die substrate 2702 may include, for example, a crystalline substrate formed using a bulk silicon or a silicon-on-insulator (SOI) substructure. In some embodiments, the die substrate 2702 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 2702. Although a few examples of materials from which the die substrate 2702 may be formed are described here, any material that may serve as a foundation for an integrated circuit device 2700 may be used. The die substrate 2702 may be part of a singulated die (e.g., the dies 2602 of FIG. 26) or a wafer (e.g., the wafer 2600 of FIG. 26).

The integrated circuit device 2700 may include one or more device layers 2704 disposed on the die substrate 2702. The device layer 2704 may include features of one or more transistors 2740 (e.g., metal oxide semiconductor field-effect transistors (MOSFETs)) formed on the die substrate 2702. The transistors 2740 may include, for example, one or more source and/or drain (S/D) regions 2720, a gate 2722 to control current flow between the S/D regions 2720, and one or more S/D contacts 2724 to route electrical signals to/from the S/D regions 2720. The transistors 2740 may include additional features not depicted for the sake of clarity, such as device isolation regions, gate contacts, and the like. The transistors 2740 are not limited to the type and configuration depicted in FIG. 27 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

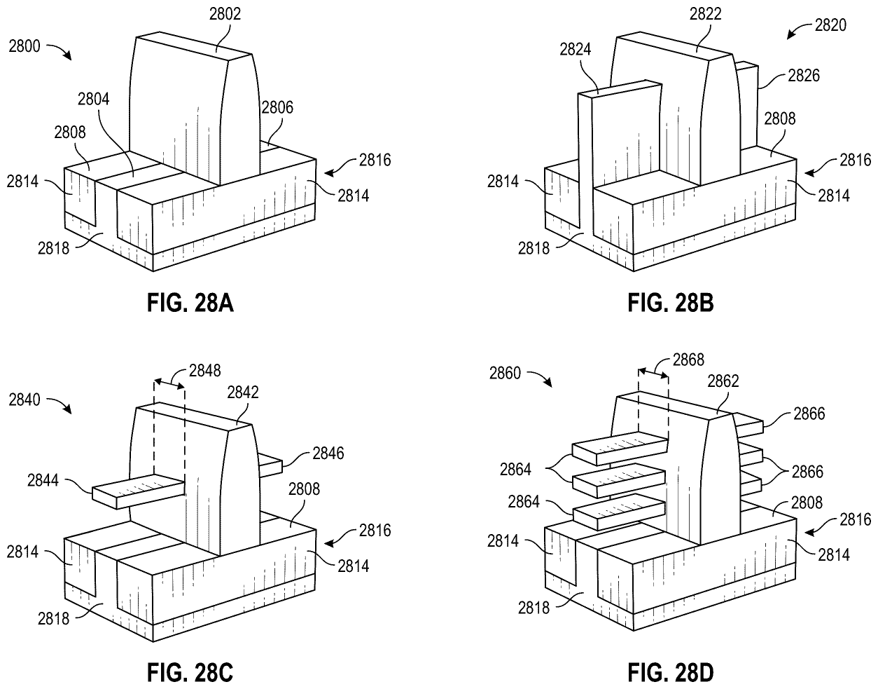

FIGS. 28A-28D are simplified perspective views of example planar, FinFET, gate-all-around, and stacked gate-all-around transistors. The transistors illustrated in FIGS. 28A-28D are formed on a substrate 2816 having a surface 2808. Isolation regions 2814 separate the source and drain regions of the transistors from other transistors and from a bulk region 2818 of the substrate 2816.

FIG. 28A is a perspective view of an example planar transistor 2800 comprising a gate 2802 that controls current flow between a source region 2804 and a drain region 2806. The transistor 2800 is planar in that the source region 2804 and the drain region 2806 are planar with respect to the substrate surface 2808.

FIG. 28B is a perspective view of an example FinFET transistor 2820 comprising a gate 2822 that controls current flow between a source region 2824 and a drain region 2826. The transistor 2820 is non-planar in that the source region 2824 and the drain region 2826 comprise “fins” that extend upwards from the substrate surface 2828. As the gate 2822 encompasses three sides of the semiconductor fin that extends from the source region 2824 to the drain region 2826, the transistor 2820 can be considered a tri-gate transistor. FIG. 28B illustrates one S/D fin extending through the gate 2822, but multiple S/D fins can extend through the gate of a FinFET transistor.

FIG. 28C is a perspective view of a gate-all-around (GAA) transistor 2840 comprising a gate 2842 that controls current flow between a source region 2844 and a drain region 2846. The transistor 2840 is non-planar in that the source region 2844 and the drain region 2846 are elevated from the substrate surface 2828.

FIG. 28D is a perspective view of a GAA transistor 2860 comprising a gate 2862 that controls current flow between multiple elevated source regions 2864 and multiple elevated drain regions 2866. The transistor 2860 is a stacked GAA transistor as the gate controls the flow of current between multiple elevated S/D regions stacked on top of each other. The transistors 2840 and 2860 are considered gate-all-around transistors as the gates encompass all sides of the semiconductor portions that extends from the source regions to the drain regions. The transistors 2840 and 2860 can alternatively be referred to as nanowire, nanosheet, or nanoribbon transistors depending on the width (e.g., widths 2848 and 2868 of transistors 2840 and 2860, respectively) of the semiconductor portions extending through the gate.

Returning to FIG. 27, a transistor 2740 may include a gate 2722 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 2740 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 2740 along the source-channel-drain direction, the gate electrode may consist of a U-shaped structure that includes a bottom portion substantially parallel to the surface of the die substrate 2702 and two sidewall portions that are substantially perpendicular to the top surface of the die substrate 2702. In other embodiments, at least one of the metal layers that form the gate electrode may simply be a planar layer that is substantially parallel to the top surface of the die substrate 2702 and does not include sidewall portions substantially perpendicular to the top surface of the die substrate 2702. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 2720 may be formed within the die substrate 2702 adjacent to the gate 2722 of individual transistors 2740. The S/D regions 2720 may be formed using an implantation/diffusion process or an etching/deposition process, for example. In the former process, dopants such as boron, aluminum, antimony, phosphorous, or arsenic may be ion-implanted into the die substrate 2702 to form the S/D regions 2720. An annealing process that activates the dopants and causes them to diffuse farther into the die substrate 2702 may follow the ion-implantation process. In the latter process, the die substrate 2702 may first be etched to form recesses at the locations of the S/D regions 2720. An epitaxial deposition process may then be carried out to fill the recesses with material that is used to fabricate the S/D regions 2720. In some implementations, the S/D regions 2720 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 2720 may be formed using one or more alternate semiconductor materials such as germanium or a group III-V material or alloy. In further embodiments, one or more layers of metal and/or metal alloys may be used to form the S/D regions 2720.

Electrical signals, such as power and/or input/output (I/O) signals, may be routed to and/or from the devices (e.g., transistors 2740) of the device layer 2704 through one or more interconnect layers disposed on the device layer 2704 (illustrated in FIG. 27 as interconnect layers 2706-2710). For example, electrically conductive features of the device layer 2704 (e.g., the gate 2722 and the S/D contacts 2724) may be electrically coupled with the interconnect structures 2728 of the interconnect layers 2706-2710. The one or more interconnect layers 2706-2710 may form a metallization stack (also referred to as an “ILD stack”) 2719 of the integrated circuit device 2700.

The interconnect structures 2728 may be arranged within the interconnect layers 2706-2710 to route electrical signals according to a wide variety of designs; in particular, the arrangement is not limited to the particular configuration of interconnect structures 2728 depicted in FIG. 27. Although a particular number of interconnect layers 2706-2710 is depicted in FIG. 27, embodiments of the present disclosure include integrated circuit devices having more or fewer interconnect layers than depicted.

In some embodiments, the interconnect structures 2728 may include lines 2728a and/or vias 2728b filled with an electrically conductive material such as a metal. The lines 2728a may be arranged to route electrical signals in a direction of a plane that is substantially parallel with a surface of the die substrate 2702 upon which the device layer 2704 is formed. For example, the lines 2728a may route electrical signals in a direction in and out of the page and/or in a direction across the page. The vias 2728b may be arranged to route electrical signals in a direction of a plane that is substantially perpendicular to the surface of the die substrate 2702 upon which the device layer 2704 is formed. In some embodiments, the vias 2728b may electrically couple lines 2728a of different interconnect layers 2706-2710 together.

The interconnect layers 2706-2710 may include a dielectric material 2726 disposed between the interconnect structures 2728, as shown in FIG. 27. In some embodiments, dielectric material 2726 disposed between the interconnect structures 2728 in different ones of the interconnect layers 2706-2710 may have different compositions; in other embodiments, the composition of the dielectric material 2726 between different interconnect layers 2706-2710 may be the same. The device layer 2704 may include a dielectric material 2726 disposed between the transistors 2740 and a bottom layer of the metallization stack as well. The dielectric material 2726 included in the device layer 2704 may have a different composition than the dielectric material 2726 included in the interconnect layers 2706-2710; in other embodiments, the composition of the dielectric material 2726 in the device layer 2704 may be the same as a dielectric material 2726 included in any one of the interconnect layers 2706-2710.

A first interconnect layer 2706 (referred to as Metal 1 or “M1”) may be formed directly on the device layer 2704. In some embodiments, the first interconnect layer 2706 may include lines 2728a and/or vias 2728b, as shown. The lines 2728a of the first interconnect layer 2706 may be coupled with contacts (e.g., the S/D contacts 2724) of the device layer 2704. The vias 2728b of the first interconnect layer 2706 may be coupled with the lines 2728a of a second interconnect layer 2708.

The second interconnect layer 2708 (referred to as Metal 2 or “M2”) may be formed directly on the first interconnect layer 2706. In some embodiments, the second interconnect layer 2708 may include via 2728b to couple the lines 2728 of the second interconnect layer 2708 with the lines 2728a of a third interconnect layer 2710. Although the lines 2728a and the vias 2728b are structurally delineated with a line within individual interconnect layers for the sake of clarity, the lines 2728a and the vias 2728b may be structurally and/or materially contiguous (e.g., simultaneously filled during a dual-damascene process) in some embodiments.

The third interconnect layer 2710 (referred to as Metal 3 or “M3”) (and additional interconnect layers, as desired) may be formed in succession on the second interconnect layer 2708 according to similar techniques and configurations described in connection with the second interconnect layer 2708 or the first interconnect layer 2706. In some embodiments, the interconnect layers that are “higher up” in the metallization stack 2719 in the integrated circuit device 2700 (i.e., farther away from the device layer 2704) may be thicker that the interconnect layers that are lower in the metallization stack 2719, with lines 2728a and vias 2728b in the higher interconnect layers being thicker than those in the lower interconnect layers.

The integrated circuit device 2700 may include a solder resist material 2734 (e.g., polyimide or similar material) and one or more conductive contacts 2736 formed on the interconnect layers 2706-2710. In FIG. 27, the conductive contacts 2736 are illustrated as taking the form of bond pads. The conductive contacts 2736 may be electrically coupled with the interconnect structures 2728 and configured to route the electrical signals of the transistor(s) 2740 to external devices. For example, solder bonds may be formed on the one or more conductive contacts 2736 to mechanically and/or electrically couple an integrated circuit die including the integrated circuit device 2700 with another component (e.g., a printed circuit board). The integrated circuit device 2700 may include additional or alternate structures to route the electrical signals from the interconnect layers 2706-2710; for example, the conductive contacts 2736 may include other analogous features (e.g., posts) that route the electrical signals to external components/

In some embodiments in which the integrated circuit device 2700 is a double-sided die, the integrated circuit device 2700 may include another metallization stack (not shown) on the opposite side of the device layer(s) 2704. This metallization stack may include multiple interconnect layers as discussed above with reference to the interconnect layers 2706-2710, to provide conductive pathways (e.g., including conductive lines and vias) between the device layer(s) 2704 and additional conductive contacts (not shown) on the opposite side of the integrated circuit device 2700 from the conductive contacts 2736.

In other embodiments in which the integrated circuit device 2700 is a double-sided die, the integrated circuit device 2700 may include one or more through silicon vias (TSVs) through the die substrate 2702; these TSVs may make contact with the device layer(s) 2704, and may provide conductive pathways between the device layer(s) 2704 and additional conductive contacts (not shown) on the opposite side of the integrated circuit device 2700 from the conductive contacts 2736. In some embodiments, TSVs extending through the substrate can be used for routing power and ground signals from conductive contacts on the opposite side of the integrated circuit device 2700 from the conductive contacts 2736 to the transistors 2740 and any other components integrated into the die 2700, and the metallization stack 2719 can be used to route I/O signals from the conductive contacts 2736 to transistors 2740 and any other components integrated into the die 2700.

Multiple integrated circuit devices 2700 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

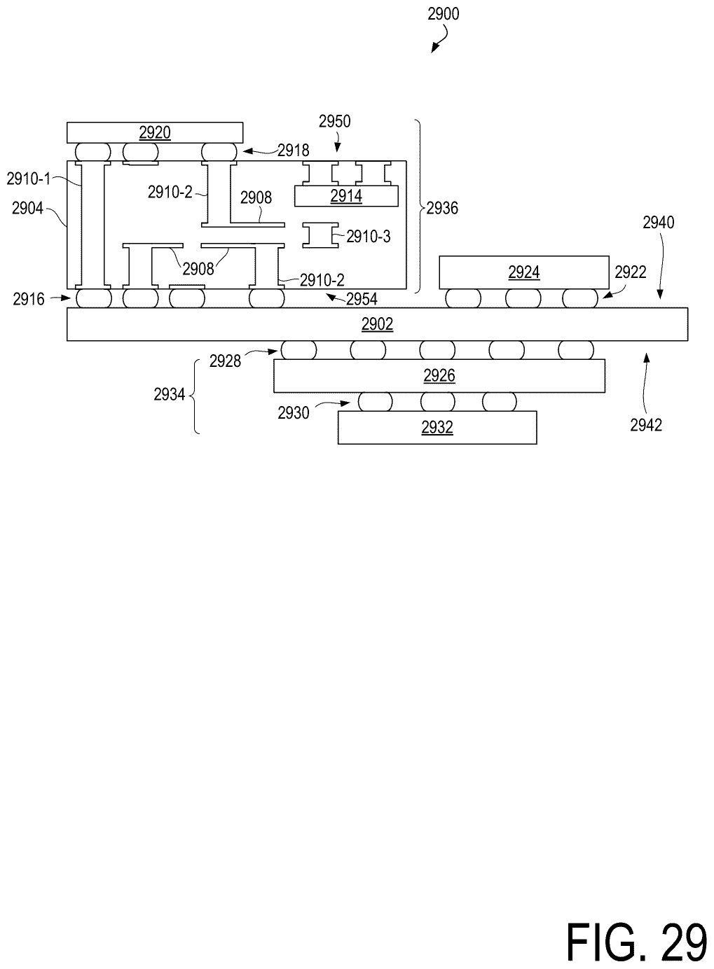

FIG. 29 is a cross-sectional side view of an integrated circuit device assembly 2900 that may include any of the microelectronic assemblies disclosed herein. In some embodiments, the integrated circuit device assembly 2900 may include a PIC die 102, which may be mated with an electronic integrated circuit die. The integrated circuit device assembly 2900 includes a number of components disposed on a circuit board 2902 (which may be a motherboard, system board, mainboard, etc.). The integrated circuit device assembly 2900 includes components disposed on a first face 2940 of the circuit board 2902 and an opposing second face 2942 of the circuit board 2902; generally, components may be disposed on one or both faces 2940 and 2942. Any of the integrated circuit components discussed below with reference to the integrated circuit device assembly 2900 may take the form of any suitable ones of the embodiments of the microelectronic assemblies disclosed herein.

In some embodiments, the circuit board 2902 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 2902. In other embodiments, the circuit board 2902 may be a non-PCB substrate. The integrated circuit device assembly 2900 illustrated in FIG. 29 includes a package-on-interposer structure 2936 coupled to the first face 2940 of the circuit board 2902 by coupling components 2916. The coupling components 2916 may electrically and mechanically couple the package-on-interposer structure 2936 to the circuit board 2902, and may include solder balls (as shown in FIG. 29), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 2936 may include an integrated circuit component 2920 coupled to an interposer 2904 by coupling components 2918. The coupling components 2918 may take any suitable form for the application, such as the forms discussed above with reference to the coupling components 2916. Although a single integrated circuit component 2920 is shown in FIG. 29, multiple integrated circuit components may be coupled to the interposer 2904; indeed, additional interposers may be coupled to the interposer 2904. The interposer 2904 may provide an intervening substrate used to bridge the circuit board 2902 and the integrated circuit component 2920.

The integrated circuit component 2920 may be a packaged or unpacked integrated circuit product that includes one or more integrated circuit dies (e.g., the die 2602 of FIG. 26, the integrated circuit device 2700 of FIG. 27) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 2920, a single monolithic integrated circuit die comprises solder bumps attached to contacts on the die. The solder bumps allow the die to be directly attached to the interposer 2904. The integrated circuit component 2920 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 2920 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 2920 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 2920 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 2904 may spread connections to a wider pitch or reroute a connection to a different connection. For example, the interposer 2904 may couple the integrated circuit component 2920 to a set of ball grid array (BGA) conductive contacts of the coupling components 2916 for coupling to the circuit board 2902. In the embodiment illustrated in FIG. 29, the integrated circuit component 2920 and the circuit board 2902 are attached to opposing sides of the interposer 2904; in other embodiments, the integrated circuit component 2920 and the circuit board 2902 may be attached to a same side of the interposer 2904. In some embodiments, three or more components may be interconnected by way of the interposer 2904.

In some embodiments, the interposer 2904 may be formed as a PCB, including multiple metal layers separated from one another by layers of dielectric material and interconnected by electrically conductive vias. In some embodiments, the interposer 2904 may be formed of an epoxy resin, a fiberglass-reinforced epoxy resin, an epoxy resin with inorganic fillers, a ceramic material, or a polymer material such as polyimide. In some embodiments, the interposer 2904 may be formed of alternate rigid or flexible materials that may include the same materials described above for use in a semiconductor substrate, such as silicon, germanium, and other group III-V and group IV materials. The interposer 2904 may include metal interconnects 2908 and vias 2910, including but not limited to through hole vias 2910-1 (that extend from a first face 2950 of the interposer 2904 to a second face 2954 of the interposer 2904), blind vias 2910-2 (that extend from the first or second faces 2950 or 2954 of the interposer 2904 to an internal metal layer), and buried vias 2910-3 (that connect internal metal layers).

In some embodiments, the interposer 2904 can comprise a silicon interposer. Through silicon vias (TSV) extending through the silicon interposer can connect connections on a first face of a silicon interposer to an opposing second face of the silicon interposer. In some embodiments, an interposer 2904 comprising a silicon interposer can further comprise one or more routing layers to route connections on a first face of the interposer 2904 to an opposing second face of the interposer 2904.

The interposer 2904 may further include embedded devices 2914, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 2904. The package-on-interposer structure 2936 may take the form of any of the package-on-interposer structures known in the art. In embodiments where the interposer is a non-printed circuit board

The integrated circuit device assembly 2900 may include an integrated circuit component 2924 coupled to the first face 2940 of the circuit board 2902 by coupling components 2922. The coupling components 2922 may take the form of any of the embodiments discussed above with reference to the coupling components 2916, and the integrated circuit component 2924 may take the form of any of the embodiments discussed above with reference to the integrated circuit component 2920.

The integrated circuit device assembly 2900 illustrated in FIG. 29 includes a package-on-package structure 2934 coupled to the second face 2942 of the circuit board 2902 by coupling components 2928. The package-on-package structure 2934 may include an integrated circuit component 2926 and an integrated circuit component 2932 coupled together by coupling components 2930 such that the integrated circuit component 2926 is disposed between the circuit board 2902 and the integrated circuit component 2932. The coupling components 2928 and 2930 may take the form of any of the embodiments of the coupling components 2916 discussed above, and the integrated circuit components 2926 and 2932 may take the form of any of the embodiments of the integrated circuit component 2920 discussed above. The package-on-package structure 2934 may be configured in accordance with any of the package-on-package structures known in the art.

FIG. 30 is a block diagram of an example electrical device 3000 that may include one or more of the microelectronic assemblies disclosed herein. For example, any suitable ones of the components of the electrical device 3000 may include one or more of the integrated circuit device assemblies 2900, integrated circuit components 2920, integrated circuit devices 2700, or integrated circuit dies 2602 disclosed herein, and may include PIC dies 102 or optical connectors 100 disclosed herein. A number of components are illustrated in FIG. 30 as included in the electrical device 3000, but any one or more of these components may be omitted or duplicated, as suitable for the application. In some embodiments, some or all of the components included in the electrical device 3000 may be attached to one or more motherboards mainboards, or system boards. In some embodiments, one or more of these components are fabricated onto a single system-on-a-chip (SoC) die.

Additionally, in various embodiments, the electrical device 3000 may not include one or more of the components illustrated in FIG. 30, but the electrical device 3000 may include interface circuitry for coupling to the one or more components. For example, the electrical device 3000 may not include a display device 3006, but may include display device interface circuitry (e.g., a connector and driver circuitry) to which a display device 3006 may be coupled. In another set of examples, the electrical device 3000 may not include an audio input device 3024 or an audio output device 3008, but may include audio input or output device interface circuitry (e.g., connectors and supporting circuitry) to which an audio input device 3024 or audio output device 3008 may be coupled.

The electrical device 3000 may include one or more processor units 3002 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 3002 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 3000 may include a memory 3004, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 3004 may include memory that is located on the same integrated circuit die as the processor unit 3002. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 3000 can comprise one or more processor units 3002 that are heterogeneous or asymmetric to another processor unit 3002 in the electrical device 3000. There can be a variety of differences between the processing units 3002 in a system in terms of a spectrum of metrics of merit including architectural, microarchitectural, thermal, power consumption characteristics, and the like. These differences can effectively manifest themselves as asymmetry and heterogeneity among the processor units 3002 in the electrical device 3000.

In some embodiments, the electrical device 3000 may include a communication component 3012 (e.g., one or more communication components). For example, the communication component 3012 can manage wireless communications for the transfer of data to and from the electrical device 3000. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 3012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 3012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 3012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 3012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 3012 may operate in accordance with other wireless protocols in other embodiments. The electrical device 3000 may include an antenna 3022 to facilitate wireless communications and/or to receive other wireless communications (such as AM or FM radio transmissions).

In some embodiments, the communication component 3012 may manage wired communications, such as electrical, optical, or any other suitable communication protocols (e.g., IEEE 802.3 Ethernet standards). As noted above, the communication component 3012 may include multiple communication components. For instance, a first communication component 3012 may be dedicated to shorter-range wireless communications such as Wi-Fi or Bluetooth, and a second communication component 3012 may be dedicated to longer-range wireless communications such as global positioning system (GPS), EDGE, GPRS, CDMA, WiMAX, LTE, EV-DO, or others. In some embodiments, a first communication component 3012 may be dedicated to wireless communications, and a second communication component 3012 may be dedicated to wired communications.

The electrical device 3000 may include battery/power circuitry 3014. The battery/power circuitry 3014 may include one or more energy storage devices (e.g., batteries or capacitors) and/or circuitry for coupling components of the electrical device 3000 to an energy source separate from the electrical device 3000 (e.g., AC line power).

The electrical device 3000 may include a display device 3006 (or corresponding interface circuitry, as discussed above). The display device 3006 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 3000 may include an audio output device 3008 (or corresponding interface circuitry, as discussed above). The audio output device 3008 may include any embedded or wired or wirelessly connected external device that generates an audible indicator, such speakers, headsets, or earbuds.

The electrical device 3000 may include an audio input device 3024 (or corresponding interface circuitry, as discussed above). The audio input device 3024 may include any embedded or wired or wirelessly connected device that generates a signal representative of a sound, such as microphones, microphone arrays, or digital instruments (e.g., instruments having a musical instrument digital interface (MIDI) output). The electrical device 3000 may include a Global Navigation Satellite System (GNSS) device 3018 (or corresponding interface circuitry, as discussed above), such as a Global Positioning System (GPS) device. The GNSS device 3018 may be in communication with a satellite-based system and may determine a geolocation of the electrical device 3000 based on information received from one or more GNSS satellites, as known in the art.

The electrical device 3000 may include an other output device 3010 (or corresponding interface circuitry, as discussed above). Examples of the other output device 3010 may include an audio codec, a video codec, a printer, a wired or wireless transmitter for providing information to other devices, or an additional storage device.

The electrical device 3000 may include an other input device 3020 (or corresponding interface circuitry, as discussed above). Examples of the other input device 3020 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 3000 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 3000 may be any other electronic device that processes data. In some embodiments, the electrical device 3000 may comprise multiple discrete physical components. Given the range of devices that the electrical device 3000 can be manifested as in various embodiments, in some embodiments, the electrical device 3000 can be referred to as a computing device or a computing system.

### Examples

Illustrative examples of the technologies disclosed herein are provided below. An embodiment of the technologies may include any one or more, and any combination of, the examples described below.

Example 1 includes an apparatus comprising a substrate comprising a top surface; a lens array comprising a plurality of lenses and one or more optical fiducials; a plurality of waveguides, wherein at least part of individual waveguides of the plurality of waveguides extend in a plane parallel to the top surface, wherein individual waveguides of the plurality of waveguides direct light through a lens of the plurality of lenses; and one or more auxiliary waveguides, wherein at least part of individual waveguides of the one or more auxiliary waveguides extend in the plane parallel to the top surface, wherein individual waveguides of the one or more auxiliary waveguides direct light through one of the one or more optical fiducials.

Example 2 includes the subject matter of Example 1, and further including one or more guide pins, wherein light transmitted through the plurality of waveguides is collimated into a plurality of beams by the lens array, wherein the one or more guide pins extend along an axis substantially parallel to the plurality of beams, wherein the axis parallel to the plurality of beams is not substantially parallel to the top surface of the substrate.

Example 3 includes the subject matter of any of Examples 1 and 2, and wherein the one or more guide pins extend along an axis within 0.1° of parallel to the plurality of beams, wherein the axis parallel to the plurality of beams has an angle of at least 0.5° relative to the top surface.

Example 4 includes the subject matter of any of Examples 1-3, and wherein the one or more optical fiducials comprise one or more opaque optical fiducials.

Example 5 includes the subject matter of any of Examples 1-4, and wherein the one or more optical fiducials comprise one or more lenslet array optical fiducials.

Example 6 includes the subject matter of any of Examples 1-5, and wherein the one or more optical fiducials are positioned in a plane different from a plane defined by the plurality of lenses and a line perpendicular to the top surface.

Example 7 includes the subject matter of any of Examples 1-6, and further including an additional one or more optical fiducials, wherein the additional one or more optical fiducials are positioned in the plane defined by the plurality of lenses and the line perpendicular to the top surface.

Example 8 includes the subject matter of any of Examples 1-7, and wherein a plurality of V-grooves are defined in the top surface, wherein individual waveguides of the plurality of waveguides are optical fibers positioned in individual V-grooves of the plurality of V-grooves.

Example 9 includes the subject matter of any of Examples 1-8, and wherein individual waveguides of the plurality of waveguides are bulk waveguides defined in the substrate.

Example 10 includes the subject matter of any of Examples 1-9, and wherein the plurality of waveguides comprises at least eight waveguides.

Example 11 includes the subject matter of any of Examples 1-10, and wherein the apparatus is an optical connector.

Example 12 includes the subject matter of any of Examples 1-11, and wherein the substrate is a photonic integrated circuit (PIC) die.

Example 13 includes an apparatus comprising a substrate comprising a top surface; a lens array comprising a plurality of lenses; a plurality of waveguides, wherein at least part of individual waveguides of the plurality of waveguides extend in a plane parallel to the top surface, wherein individual waveguides of the plurality of waveguides direct light through a lens of the plurality of lenses; and means for determining a position of the lens array relative to the substrate.

Example 14 includes the subject matter of Example 13, and wherein the means for determining a position of the lens array relative to the substrate comprises one or more optical fiducials on the lens array; and one or more auxiliary waveguides, wherein at least part of individual waveguides of the one or more auxiliary waveguides extend in the plane parallel to the top surface, wherein individual waveguides of the one or more auxiliary waveguides direct light through one of the one or more optical fiducials.

Example 15 includes the subject matter of any of Examples 13 and 14, and wherein the one or more optical fiducials comprise one or more opaque optical fiducials.

Example 16 includes the subject matter of any of Examples 13-15, and wherein the one or more optical fiducials comprise one or more lenslet array optical fiducials.

Example 17 includes the subject matter of any of Examples 13-16, and wherein the one or more optical fiducials are positioned in a plane different from a plane defined by the plurality of lenses and a line perpendicular to the top surface.

Example 18 includes the subject matter of any of Examples 13-17, and wherein the means for determining a position of the lens array relative to the substrate comprises further comprises an additional one or more optical fiducials, wherein the additional one or more optical fiducials are positioned in the plane defined by the plurality of lenses and the line perpendicular to the top surface.

Example 19 includes the subject matter of any of Examples 13-18, and wherein the means for determining a position of the lens array relative to the substrate comprises one or more reference optical fibers, wherein, when carrying light, the one or more reference optical fibers do not direct light through the lens array.

Example 20 includes the subject matter of any of Examples 13-19, and wherein the means for determining a position of the lens array relative to the substrate comprises one or more guide pins, wherein light transmitted through the plurality of waveguides is collimated into a plurality of beams by the lens array, wherein the one or more guide pins extend along an axis substantially parallel to the plurality of beams, wherein the axis parallel to the plurality of beams is not substantially parallel to the top surface of the substrate.

Example 21 includes the subject matter of any of Examples 13-20, and wherein the one or more guide pins extend along an axis within 0.1° of parallel to the plurality of beams, wherein the axis parallel to the plurality of beams has an angle of at least 0.5° relative to the top surface.

Example 22 includes the subject matter of any of Examples 13-21, and wherein a plurality of V-grooves are defined in the top surface, wherein individual waveguides of the plurality of waveguides are optical fibers positioned in individual V-grooves of the plurality of V-grooves.

Example 23 includes the subject matter of any of Examples 13-22, and wherein individual waveguides of the plurality of waveguides are bulk waveguides defined in the substrate.

Example 24 includes the subject matter of any of Examples 13-23, and wherein the plurality of waveguides comprises at least eight waveguides.

Example 25 includes the subject matter of any of Examples 13-24, and wherein the apparatus is an optical connector.

Example 26 includes the subject matter of any of Examples 13-25, and wherein the substrate is a photonic integrated circuit (PIC) die.

Example 27 includes a method comprising positioning a lens array at an edge of a substrate, wherein a plurality of waveguides are on or near a top surface of the substrate, wherein the lens array comprises a plurality of lenses; sending light through one or more of the plurality of waveguides; detecting light from one or more of the plurality of waveguides that passed through the lens array; and determining an indication of a position of the lens array relative to the plurality of waveguides based on the detected light from one or more of the plurality of waveguides that passed through the lens array.

Example 28 includes the subject matter of Example 27, and further including determining an indication of an orientation of the lens array relative to the plurality of waveguides based on the detected light from one or more of the plurality of waveguides that passed through the lens array.

Example 29 includes the subject matter of any of Examples 27 and 28, and further including repositioning the lens array to a new position based on the determined indication of the position of the lens array relative to the plurality of waveguides; and permanently attaching the lens array to the substrate at the new position.

Example 30 includes the subject matter of any of Examples 27-29, and further including positioning one or more guide pins based on the determined indication of the position of the lens array relative to the plurality of waveguides.

Example 31 includes the subject matter of any of Examples 27-30, and further including determining a direction of one or more beams from the plurality of waveguides that are collimated by the plurality of lenses, wherein positioning the one or more guide pins comprises positioning the one or more guide pins based on the direction of the one or more beams.

Example 32 includes the subject matter of any of Examples 27-31, and further including adjusting a parameter of a process for positioning lens arrays based on the determined indication of the position of the lens array relative to the plurality of waveguides.

Example 33 includes the subject matter of any of Examples 27-32, and wherein the lens array comprises one or more optical fiducials, wherein detecting light from the one or more of the plurality of waveguides that passed through the lens array comprises detecting light from the one or more of the plurality of waveguides that passed the one or more optical fiducials.

Example 34 includes the subject matter of any of Examples 27-33, and wherein the one or more optical fiducials comprise one or more opaque optical fiducials.

Example 35 includes the subject matter of any of Examples 27-34, and wherein the one or more optical fiducials comprise one or more lenslet array optical fiducials.

Example 36 includes the subject matter of any of Examples 27-35, and wherein the one or more optical fiducials are positioned in a plane different from a plane defined by the plurality of lenses and a line perpendicular to the top surface.

Example 37 includes the subject matter of any of Examples 27-36, and wherein the lens array further comprises an additional one or more optical fiducials, wherein the additional one or more optical fiducials are positioned in the plane defined by the plurality of lenses and the line perpendicular to the top surface.

Example 38 includes the subject matter of any of Examples 27-37, and wherein a plurality of V-grooves are defined in the top surface, wherein individual waveguides of the plurality of waveguides are optical fibers positioned in individual V-grooves of the plurality of V-grooves.

Example 39 includes the subject matter of any of Examples 27-38, and wherein individual waveguides of the plurality of waveguides are bulk waveguides defined in the substrate.

Example 40 includes the subject matter of any of Examples 27-39, and wherein the plurality of waveguides comprises at least eight waveguides.

Example 41 includes the subject matter of any of Examples 27-40, and wherein the lens array, the substrate, and the plurality of waveguides are part of an optical connector.

Example 42 includes the subject matter of any of Examples 27-41, and wherein the substrate is a photonic integrated circuit (PIC) die.

1. An apparatus comprising:
a substrate comprising a top surface;
a lens array comprising a plurality of lenses and one or more optical fiducials;
a plurality of waveguides, wherein at least part of individual waveguides of the plurality of waveguides extend in a plane parallel to the top surface, wherein individual waveguides of the plurality of waveguides direct light through a lens of the plurality of lenses; and
one or more auxiliary waveguides, wherein at least part of individual waveguides of the one or more auxiliary waveguides extend in the plane parallel to the top surface, wherein individual waveguides of the one or more auxiliary waveguides direct light through one of the one or more optical fiducials.

2. The apparatus of claim 1, further comprising one or more guide pins,
wherein light transmitted through the plurality of waveguides is collimated into a plurality of beams by the lens array, wherein the one or more guide pins extend along an axis substantially parallel to the plurality of beams, wherein the axis parallel to the plurality of beams is not substantially parallel to the top surface of the substrate.

3. The apparatus of claim 2, wherein the one or more guide pins extend along an axis within 0.1° of parallel to the plurality of beams, wherein the axis parallel to the plurality of beams has an angle of at least 0.5° relative to the top surface.

4. The apparatus of claim 1, wherein the one or more optical fiducials comprise one or more opaque optical fiducials.

5. The apparatus of claim 1, wherein the one or more optical fiducials comprise one or more lenslet array optical fiducials.

6. The apparatus of claim 1, wherein the one or more optical fiducials are positioned in a plane different from a plane defined by the plurality of lenses and a line perpendicular to the top surface.

7. The apparatus of claim 6, further comprising an additional one or more optical fiducials, wherein the additional one or more optical fiducials are positioned in the plane defined by the plurality of lenses and the line perpendicular to the top surface.

8. The apparatus of claim 1, wherein a plurality of V-grooves are defined in the top surface, wherein individual waveguides of the plurality of waveguides are optical fibers positioned in individual V-grooves of the plurality of V-grooves.

9. The apparatus of claim 1, wherein individual waveguides of the plurality of waveguides are bulk waveguides defined in the substrate.

10. The apparatus of claim 1, wherein the plurality of waveguides comprises at least eight waveguides.

11. The apparatus of claim 1, wherein the apparatus is an optical connector.

12. The apparatus of claim 1, wherein the substrate is a photonic integrated circuit (PIC) die.

13. An apparatus comprising:
a substrate comprising a top surface;
a lens array comprising a plurality of lenses;
a plurality of waveguides, wherein at least part of individual waveguides of the plurality of waveguides extend in a plane parallel to the top surface, wherein individual waveguides of the plurality of waveguides direct light through a lens of the plurality of lenses; and
means for determining a position of the lens array relative to the substrate.

14. The apparatus of claim 13, wherein the means for determining a position of the lens array relative to the substrate comprises:
one or more optical fiducials on the lens array; and
one or more auxiliary waveguides, wherein at least part of individual waveguides of the one or more auxiliary waveguides extend in the plane parallel to the top surface, wherein individual waveguides of the one or more auxiliary waveguides direct light through one of the one or more optical fiducials.

15. The apparatus of claim 14, wherein the one or more optical fiducials comprise one or more opaque optical fiducials.

16. The apparatus of claim 14, wherein the one or more optical fiducials comprise one or more lenslet array optical fiducials.

17. The apparatus of claim 14, wherein the one or more optical fiducials are positioned in a plane different from a plane defined by the plurality of lenses and a line perpendicular to the top surface.

18. The apparatus of claim 13, wherein the means for determining a position of the lens array relative to the substrate comprises:
one or more reference optical fibers, wherein, when carrying light, the one or more reference optical fibers do not direct light through the lens array.

19. The apparatus of claim 13, wherein the means for determining a position of the lens array relative to the substrate comprises one or more guide pins,
wherein light transmitted through the plurality of waveguides is collimated into a plurality of beams by the lens array, wherein the one or more guide pins extend along an axis substantially parallel to the plurality of beams, wherein the axis parallel to the plurality of beams is not substantially parallel to the top surface of the substrate.

20. A method comprising:
positioning a lens array at an edge of a substrate, wherein a plurality of waveguides are on or near a top surface of the substrate, wherein the lens array comprises a plurality of lenses;
sending light through one or more of the plurality of waveguides;
detecting light from one or more of the plurality of waveguides that passed through the lens array; and
determining an indication of a position of the lens array relative to the plurality of waveguides based on the detected light from one or more of the plurality of waveguides that passed through the lens array.

21. The method of claim 20, further comprising:
determining an indication of an orientation of the lens array relative to the plurality of waveguides based on the detected light from one or more of the plurality of waveguides that passed through the lens array.

22. The method of claim 20, further comprising:
repositioning the lens array to a new position based on the determined indication of the position of the lens array relative to the plurality of waveguides; and
permanently attaching the lens array to the substrate at the new position.

23. The method of claim 20, further comprising positioning one or more guide pins based on the determined indication of the position of the lens array relative to the plurality of waveguides.

24. The method of claim 23, further comprising determining a direction of one or more beams from the plurality of waveguides that are collimated by the plurality of lenses,
wherein positioning the one or more guide pins comprises positioning the one or more guide pins based on the direction of the one or more beams.

25. The method of claim 20, further comprising adjusting a parameter of a process for positioning lens arrays based on the determined indication of the position of the lens array relative to the plurality of waveguides.
